(19) United States
(12) Patent Application Publication
(10) Pub. No.: US 2007/0132659 A1
(43) Pub. Date: Jun. 14, 2007

(54) Apparatus and method for displaying image

(75) Inventors: Tetsuo Maruyama, Tokyo (JP); Izumi Noma, Tokyo (JP); Hirofumi Jingushi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Sony Corporation, Shinagawa-ku (JP); Coder Electronics Corporation, Nakano-ku (JP)

(21) Appl. No.: 11/495,574

(22) Filed: Jul. 31, 2006

(30) Foreign Application Priority Data
Aug. 1, 2005 (JP) 2005-223291

(51) Int. Cl. G09G 5/00; G03B 21/00

(52) U.S. Cl. 345/1.1; 353/13

(57) ABSTRACT

An apparatus for displaying image has plural display devices for receiving and flashing still images to provide a consecutive image, which are arranged along a route of a mobile object. The apparatus has a speed detection device for detecting a traveling speed of the object and a control section for allowing a flash pulse supplied to the display devices to be generated, based on the traveling speed of the object. The apparatus has a display control section for controlling the display devices, which includes an image memory for storing data on plural separate still images and a light emission drive section for driving the display panel to which the flash pulse is supplied, thereby to flash sequentially the still images on the display panel. The display control section selects the plural still images sequentially one-by-one and writes the data on still images into the display panel.

### CROSSREFERENCE TO RELATED APPLICATION

The present invention contains subject matters related to Japanese Patent Applications JP 2005-223291 and JP 2006-157534 filed in the Japanese Patent Office on Aug. 1, 2005 and Jun. 6, 2006, respectively, the entire contents of which being incorporated herein by reference.

### BACKGROUND OF THE INVENTION

1. Field of the Invention

The present invention relates to an apparatus and a method for displaying image in which passengers put on a mobile object traveling or moving, like an electric train traveling on rails, can view still images as a continuously-moving image (motion image).

2. Description of Related Art

Japanese Patent Application Publication No. 2000-172220 has proposed an apparatus for displaying image in which plural frames of still images are separately arranged side-by-side on, for example, a wall surface in a tunnel along rails of a railroad and flashed so that when the electric train enters into the tunnel, passengers put on the electric train can view the still images flashed on the wall of the tunnel as a motion image through a window of the electric train.

In this case, as shown in FIG. 1, the apparatus 1 for displaying image is constituted of plural display devices 6 arranged with them being apart from each other at a predetermined distance on a wall surface 5a in a tunnel 5. If the display devices 6 flash still images of frames that constitute a motion image, passengers on an electric train 4 moving at a predetermined speed can visually recognize frame-stepping images as a motion image through a window 4a of the electric train 4. Thus, even if frame-stepping still images are provided, the passengers can view a motion image similar to TV image.

To recognize visually with the human eye consecutive still images as a motion image, a frame rate of 24 frames per second (24 frames/s) could be necessary for a movie, a frame rate of 30 frames/s could be necessary on TV by NTSC standards, and a frame rate of 25 frames/s could be necessary by PAL standards. Therefore, to obtain an ordinary motion image, a frame rate of at least 24 frames/s can be necessary.

For example, an installation spacing for the display devices 6 (e.g., a flat display panel such as an LCD panel) to display still images at a frame rate of 30 frames/s varies with a traveling speed of the electric train 4. For example, if the traveling speed of the electric train 4 is 40 km/h, the installation spacing of 37 cm is necessitated, and if the traveling speed thereof is 60 km/h, the installation spacing of 53 cm is necessitated.

It has been known that to provide passengers with a stable and natural motion image even when the traveling speed of the electric train 4 changes, the timing at which the display devices 6 flash is controlled in accordance with the traveling speed of the electric train 4. Japanese Patent Application Publication No. H11-202818 has disclosed a mobile object-dedicated display apparatus and a method therefor in which a stable image can be attained in accordance with the speed of the mobile object.

A motion image constituted of still images is equally provided for all passengers on every carriage on the electric train 4. For example, to provide a motion image for four seconds (e.g., motion image A) by using still images having a frame rate of 30 frames/s, as shown in FIG. 2, the 120 display devices 6 (6a, 6b, 6c, . . . , and 6n: n=120) are arranged in a traveling direction of the electric train 4 and intermittently supplied with the corresponding frame #i (i=1-120) of still images so as to provide a motion image that is completed for four seconds. It should be noted that FIG. 2 and subsequent figures show LCD panels as the display devices 6, so that the display devices 6 are denoted as “LCD terminal #”.

### SUMMARY OF THE INVENTION

Since the types (contents) of motion images that can be provided for passengers are not limited to one, contents of still images can be arbitrarily changed. For example, a plurality of image sources (video sources) can be prepared so as to be appropriately selected and supplied, thereby switching motion images for every electric train or time zones to provide different motion images at different times when the trains pass by. However, in this case, all the passengers on the same electric train will without fail view the same motion image.

As shown in FIG. 2, although a passenger A would appear as if the same still image was being displayed with respect to himself or herself, he or she can also actually appear, with respect to, for example, a still image A of frame #4 facing him or her, an earlier still image A (still image A of frame #3) by one frame that is displayed at the left-side display device (flat display panel) 6c and a later (future) still image A (still image A of frame #5) by one frame that is displayed at the right-side display device 6e. This causes the passenger A to view the still images A of these consecutive frames simultaneously.

Therefore, if different motion images can be displayed at mutually adjacent display devices 6 that are within the field vision of the passenger A but are not facing to him or her, the passenger A can be supplied with plural motion images as if plural TV images were within his or her field of vision. On the other hand, another passenger next to the passenger A can be supplied with another motion image that is different from that for the passenger A.

The following will describe an example of displaying three separate still images with reference to FIG. 3. FIG. 3 illustrates a case of displaying the three separate still images at a certain display timing (flash timing). A display device 6d facing the passenger A displays a still image B of frame #4; a left-side display device 6c displays a still image C of frame #3; and a right-side display device 6e displays the still image A of frame #5. This enables the passenger A to enjoy viewing the three different still images simultaneously. Another passenger adjacent to the passenger A can enjoy viewing still image that is different from that for the passenger A.

FIGS. 4A-4E show, in the case of three separate still images, how to switch the still images along an advancing direction of the electric train. At the first flash timing (for first emission timing of light) t=0, the display device 6a displays the still image A (of frame #1), and thus, the passenger A can view this still image A (FIG. 4A).

At the next flash timing t=Δt, as shown in FIG. 4B, the second display device 6b displays the still image A (of frame #2) and the passenger A can view the still image A continuously. Simultaneously, the first display device 6a displays the still image B (of frame #1) and a passenger B positioned next to the passenger A can view the still image B. The passenger A can also view this still image B sideways.

At the next flash timing t=2Δt, as shown in FIG. 4C, the third display device 6c displays the still image A (of frame #3) and the passenger A can view the still image A continuously. Simultaneously, the second display device 6b displays the still image B (of frame #2). The passenger A, as well as, of course, the passenger B positioned next to the passenger A can view this still image B. Further, the first display device 6a displays the still image C (of frame #1) and a passenger C positioned next to passenger B can view the still image C. The passenger B can thus view the still images C and A.

At the next flash timing t=3Δt, display positions of the still images A, B, and C and the frame numbers are each shifted by one frame and the first display device 6a displays the still image A (of frame #1). By thus continually displaying the still images with them being switched, different plural motion images can be provided simultaneously to passengers put on the same train. This holds true also with t=4Δ and subsequent timings (FIG. 4D).

However, as described above, in order to allow the passenger to view a TV image, still images having a frame rate of 30 frames/s are necessitated. Ideally, timing at which items of image data are overwritten from an image memory to the display devices 6 and a flash timing at the display devices 6 are synchronized with a vertical synchronization signal VP at a certain traveling speed. For example, if the traveling speed is 60 km/h, it is also possible to design the apparatus in such a manner as to synchronize both the timing of writing and the flash timing with the vertical synchronization signal VP.

However, the traveling speed of the train 4 may be not kept constant, so that the timing of writing and the flash timing may be different from each other. In such a case, these timings are not synchronized, and thus differ from one another.

The identical display device 6 flashes plural separate still images sequentially with them being switched from one to another. If the flash timing is shifted gradually in relation to the timing of the writing while image data of the immediately preceding still image that has already been flashed is overwritten by the image data of a new still image to be flashed, next flash timing may occur.

This is because, as is well-known, to use a flat display panel such as an LCD panel and/or a plasma display panel as display panels of the display devices 6, it is necessary to perform any processing (refresh processing) so as to write image data repeatedly onto each picture element (each pixel).

If flash pulses are supplied when items of image data of mutually different still images are written onto the same display device 6 in such a manner, an unstable still image may be displayed. This is because, in order to depict image information that has been written, at least a reaction time, referred to as a response time, is necessitated between the moment of writing and the moment of display. As described above, if items of image data of two still images are mixed as image information at the same display device 6, the image data written latest is displayed as an unstable image because a period of time that has elapsed since writing is brief in relation to the reaction time, and that no stable display of a motion image is guaranteed.

In view of the above, it is desirable to provide an apparatus and a method for displaying image, according to which a stable motion image can be displayed by writing image data in synchronization with a flash at a display device (specifically, a display panel) even when the timing of writing the image data onto the display device and the timing of flashing at the display device are different to one another.

According to an embodiment of the present invention, there is provided an apparatus for displaying image. The apparatus has plural display devices separately arranged to each other at a predetermined distance along a route of a mobile object. The display devices receives and flashes still images to provide a consecutive image constituted of the still images. Each of the display devices has a display panel arranged at a position thereof that can be viewed from a passenger on the mobile object. The apparatus also has a speed detection device for detecting a traveling speed of the mobile object and a control section for allowing to be generated, on the basis of the traveling speed of the mobile object obtained from the speed detection device, a flash pulse to be supplied to the display devices. The apparatus further has a display control section for controlling the display devices to flash the still images sequentially on the display panel provided for each of the display devices. The display control section includes an image memory for storing items of data on plural separate still images and a light emission drive section for driving the display panel to which the flash pulse is supplied. The display control section conducts writing control to select the plural still images sequentially one-by-one and to write the items of data on the still images onto the display panel.

According to another embodiment of the present invention, there is provided a method for displaying image in which still images to be supplied to the plural display devices are flashed to provide a consecutive image constituted of the still images, each of the display devices being separately arranged to each other at a predetermined distance along a route of a mobile object. The method includes a first step of supplying plural separate still images to the same display device and flashing the still images sequentially at predetermined time intervals. The method also includes a second step of writing image data of the still images onto the display devices in synchronization with a light-emission flash pulse supplied to the display devices.

In these embodiments of the invention, an image memory for storing items of data on plural separate still images is provided to enable these separate still images to be flashed. This image memory is provided onto each of the display devices (specifically, display panels). For example, if the m'th display device, as counted from the first one, flashes a still image of the m'th frame, the image memory stores plural still images corresponding to this m'th frame. If flashing three still images A, B, and C sequentially while they are switched from one to another, the still images B, C, and A are read, for example, in that order and flashed sequentially.

On the (m−1)'th display device, the corresponding image memory stores items of image data on the still images A, B, and C of the (m−1)'th frame and, in the case of the above example, the still images C, B, and A are read therefrom in that order and flashed sequentially.

Similarly, on the (m+1)'th display device, the corresponding image memory stores items of image data of the still images A, B, and C of the (m+1)'th frame and the still images C, B, and A are read therefrom in that order and flashed sequentially.

Supposing that, for convenience of explanation, a passenger stays at a certain flash timing, when the display device displays the still image β facing the passenger, the left-side display device displays the still image C and the right-side display device displays the still image A. At the next flash timing, the display device facing the passenger displays the still image C and the left-side and right-side display devices respectively display the still images A and B. At the following flash timing, the display device facing the passenger displays the still image A and the left-side and right-side display devices respectively display the still images B and C. Therefore, at the same display device, at each flash timing, still images A, B, C, A, B, . . . , are sequentially flashed with them being switched in that order.

A timing of writing image data onto the display device is synchronized with the flash timing. In particular, immediately after a flash thereof has been performed, it starts writing items of the image data. This is done in order to prevent still images from being flashed unstably, and to achieve a flash with taking into consideration a reaction time peculiar to a flat display panel such as an LCD panel as the display device.

Immediately after light-emitting pulses have been turned on, image data to be next read is read and written sequentially onto the LCD panel. During a period of time before the next flash starts, the same image data is read and written sequentially. The image data of the previous frame that has already been written is thus only overwritten before the next flash starts, and even when a flash timing occurs before this image data of the previous frame has been completely overwritten, the image data that is yet to be overwritten and the image data that has already been completely overwritten are still both the image data of the same frame. In other words, different items of image data are not written onto the same LCD panel and flashed in that state.

Further, image data written immediately before a flash timing is the same as one written one frame earlier, and thus has a degree of reaction time that is necessary for providing the next image display.

In other words, in the embodiments of the present invention, the same display device flashes plural separate still images sequentially at predetermined time intervals, and immediately after a flash caused by light-emission flash pulses has been supplied to this display device, image data of the still images is written onto the display device in synchronization with these flash pulses supplied to this display device. By conducting this kind of flash control, it is at all times possible to prevent an unstable display of images, and thereby achieve a stable display of a motion image.

According to the embodiments of the present invention, plural display devices are arranged at positions that can be seen from a passenger on a mobile object. The display device includes a flat display panel such as an LCD panel and a light-emitting device for use on it. The flat display panel may be a flat display panel having a strip shape, or alternatively a two-dimensional flat display panel capable of flashing a full-size still image.

In a case where a display panel having a strip shape is used, a full-size still image is divided and flashed, and items of data on still images that match a display size of the display panel among items of data on this full-size still image are supplied sequentially so as to flash sequentially parts of the full-size still image, thereby flashing the full-size still image within a display period of one flash pulse.

For example, in a case where one screen on the display panel is made up of m number of horizontal pixels and n number of vertical pixels, in order to use a strip-shaped flat display panel having (1/m, n) number of pixels, all the items of data on still image of one screen is divided into m number of strip-shaped segments, which are in turn then flashed sequentially over a flash period of one flash pulse.

In such a strip-shaped flat display panel, a light-emitting diode (LED) is used. Use of such a self-luminous display element allows the flat display panel used to be made very inexpensive.

According to the embodiments of the present invention, the speed detection device detects a traveling speed of the mobile object and the control section allows to be generated, on the basis of the traveling speed of the mobile object obtained from the speed detection device, a light-emitting flash pulse (light-emitting pulse) that is to be supplied to each of the display devices. Thus, this control section can provide a flash pulse having a flash cycle that matches the traveling speed thereof.

According to the embodiments of the present invention, a display control section controls the display devices. This display control section includes the image memory for storing plural separate still images as described above, as well as the light emission drive section supplied with flash pulses and an image memory selection section for selecting image memory in which the items of data on the plural still images are stored.

According to the embodiments of the present invention, the light emission drive section drives a light-emitting device attached to the LCD panel. The image memory selection section conducts any writing control of selecting plural still images sequentially one-by-one and writing their items of image data onto the display panel in synchronization with the flash pulse. The image memory selection section further conducts any writing control of writing the items of image data onto the display device in synchronization with the flash pulses immediately after a flash caused by the flash pulses. This light-emission drive section can be omitted if a light-emitting diode is used in the display panel.

According to the embodiments of the present invention, plural separate still images are flashed on the same display device sequentially at predetermined time intervals and, immediately after a flash caused by light-emission flash pulses supplied to the display devices, items of the image data on the still images are written onto the display devices in synchronization with the flash pulses.

This avoids unstable display of images even when the timing of reading items of the image data on plural still images and the timing of flash for the display devices are asynchronous with each other. It is thus possible to achieve stability of display of a motion image even when the motion image is displayed by use of plural separate still images.

The concluding portion of this specification particularly points out and directly claims the subject matter of the present invention. However, those skilled in the art will best understand both the organization and method of operation of the invention, together with further advantages and objects thereof, by reading the remaining portions of the specification in view of the accompanying drawing(s) wherein like reference characters refer to like elements.

### BRIEF DESCRIPTION OF THE DRAWINGS

FIG. 1 is a diagram for illustrating a configuration of an apparatus for displaying image according to related art;

FIG. 2 is an illustration for showing an example of displaying a motion image constituted of a single species of still images;

FIG. 3 is an illustration for showing an example of displaying a motion image constituted of plural separate still images (No. 1);

FIGS. 4A through 4E are illustrations each for showing an example of displaying a motion image constituted of plural separate still images (No. 2);

FIG. 5 is an explanatory diagram for showing an outline of an apparatus for displaying image according to an embodiment of the invention in a case where the apparatus is used in a tunnel;

FIG. 6 is a system diagram of important components in the apparatus for displaying image according to an embodiment of the invention for showing a relationship between a display control section and an LCD panel that are provided on the apparatus;

FIG. 7 is a system diagram of important components in the apparatus for displaying image according to an embodiment of the invention for showing a configuration of a control section provided on the apparatus;

FIG. 8 is an explanatory diagram for showing how to display plural separate still images;

FIG. 9 is another explanatory diagram for showing how to display plural separate still images more in detail;

FIGS. 10A through 10D are timing charts for showing a relationship between a vertical synchronization signal and each flash pulse;

FIGS. 11A through 11G are explanatory diagrams for showing an example of flash processing at a frame rate of 30 frames/s;

FIGS. 12A through 12G are explanatory diagrams for showing an example of flash processing at a frame rate of 24 frames/s;

FIG. 13 is an illustration for showing an outline of an apparatus for displaying image according to another embodiment of the invention in which a seamless configuration is employed;

FIG. 14 is a diagram for showing an example of display processing of plural still images;

FIG. 15 is a diagram for showing a configuration of an image delivery system by way of a network;

FIG. 16 is an explanatory diagram of pixel matrix according to further embodiment of the present invention;

FIG. 17 is a conceptual diagram of a display panel having a strip shape that is used in this further embodiment of the present invention;

FIG. 18 is a block diagram for showing a configuration of a display control section when the strip-shaped display panel of FIG. 13 is used therein; and

FIGS. 19A through 19C are waveform charts each for showing a relationship with drive pulses used in the case of FIG. 17.

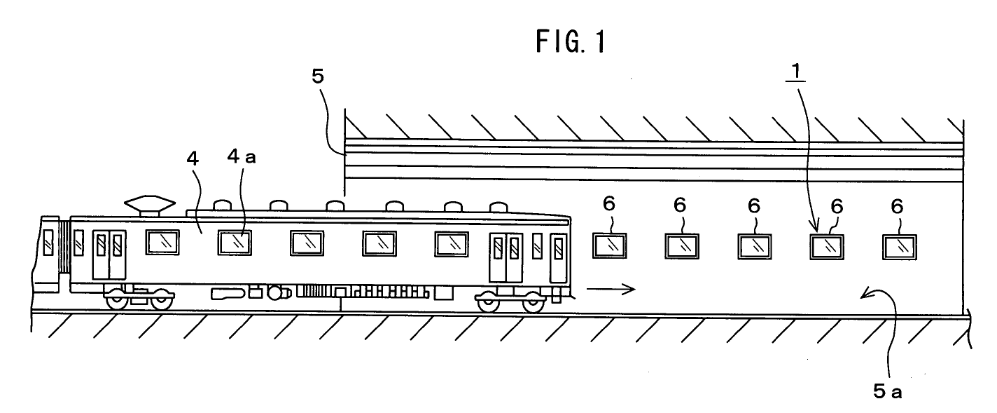

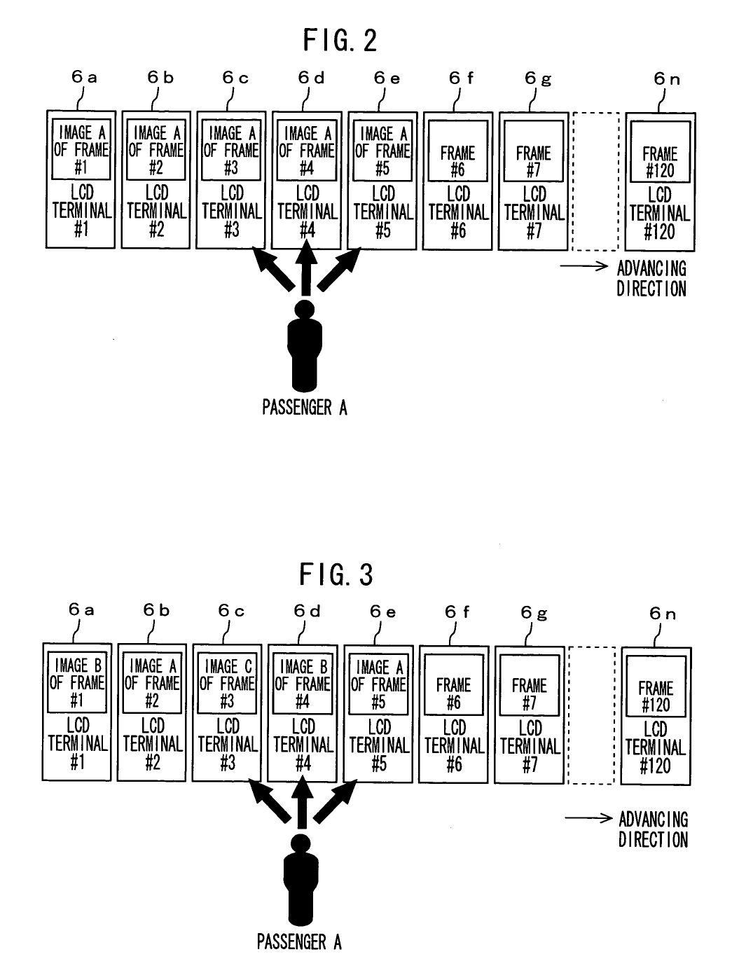

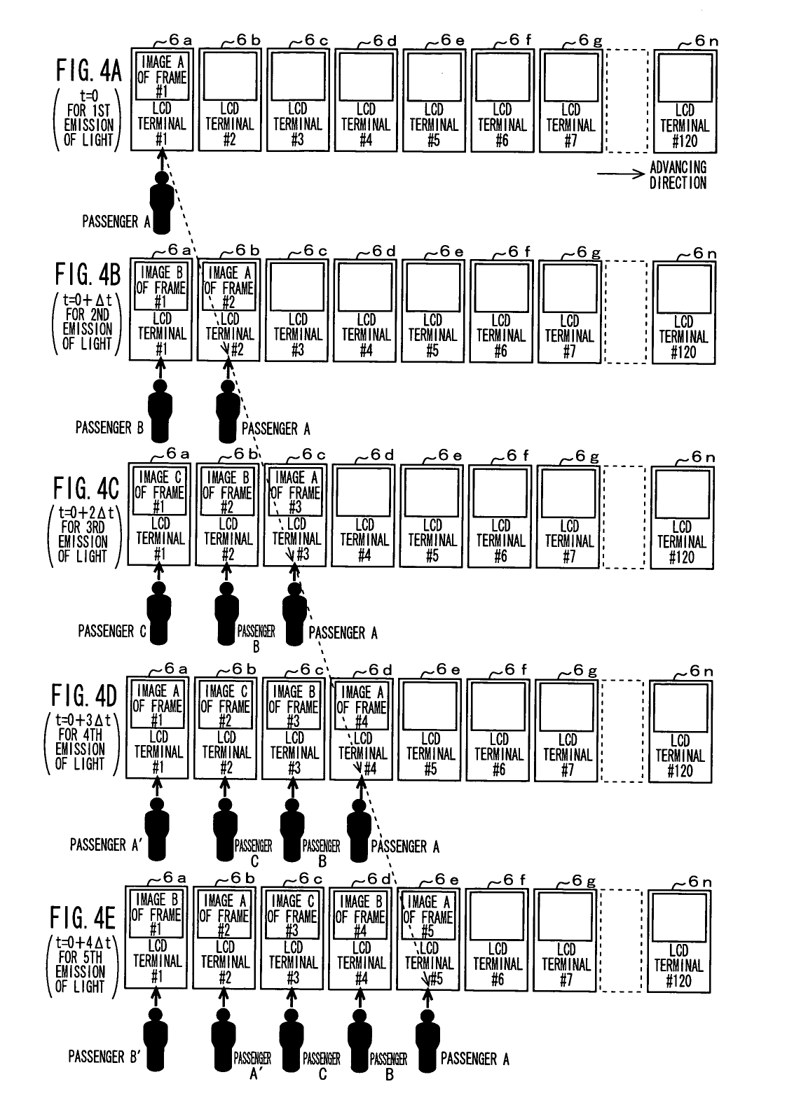

### DESCRIPTION OF THE PREFERRED EMBODIMENTS

The following will describe an apparatus and a method for displaying image according to preferred embodiments of the present invention with reference to drawings.

In the embodiments of the present invention also, similar to the related art as described above, plural display devices arranged at predetermined distance on a wall surface in a tunnel faced by a passenger put on a mobile object, for example, an electric train in a traveling direction (advancing direction) thereof and a control system for supplying to these plural display devices image data on still images desired constitutes the apparatus for displaying image.

### First Embodiment

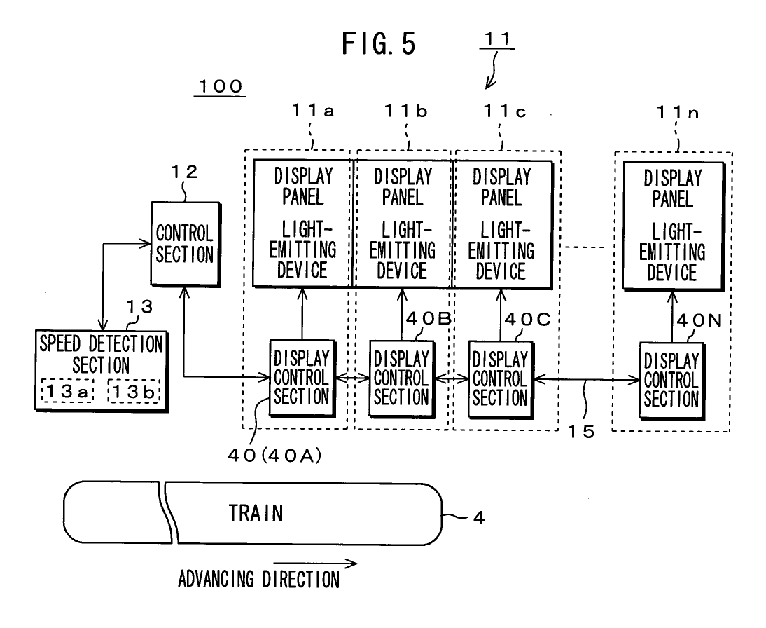

FIG. 5 shows an outline of a configuration of an apparatus 100 for displaying image related to an embodiment of the present invention. The apparatus 100 has display devices 11a, 11b, 11c, . . , and 11n, a control section 12, and a speed detection section 13.

As the display devices 11a, 11b, 11c, . . , and 11n, a full-size two-dimensional display panel can be used that is capable of displaying one-screen contents simultaneously, for example, a flat display panel such as an LCD panel.

FIG. 5 illustrates a liquid crystal display (LCD) panel. Plural LCD display devices 11a, 11b, 11c, . . , and 11n are arranged at a predetermined distance along a traveling route of the electric train, in the same way as in the related art described above.

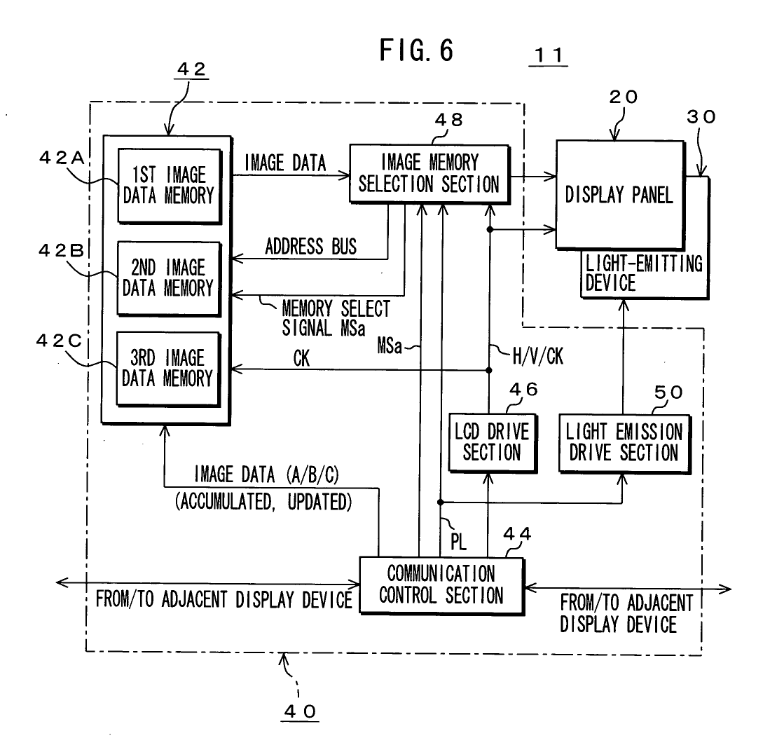

Each of the LCD devices 11a, 11b, 11c, . . , and 11n has a display panel 20, a light-emitting device 30, and a display control section 40 as shown in FIG. 6. The display panel 20 may be of a reflection type, or of a transparent type. In the present embodiment, the display panel is a transparent type LCD with a display screen of a size of about 20 inches. Therefore, a light-emitting device 30 functions as a so-called backlight and either in a flash light (strobe light) or an incandescent LED can accordingly be used as the light-emitting device 30. Turning on the light-emitting device 30 instantaneously ensures that, image information supplied (written) onto the display panel 20 can be displayed as a still image. Flash control (strobe control) is conducted on the light-emitting device 30 so as to reproduce a motion image by use of frame-stepping still images.

It should be noted that in a case where a flash light is used as the light-emitting device 30, a flash light drive circuit (which will be described later) operates as a light emission drive section 50 in response to a flash pulse PL used to control flash. This pulse is represented by a predetermined duty ratio.

The display panel 20 and the light-emitting device 30 are controlled on the basis of the display control section 40. In order to accumulate image data on plural separate still images, the display control section 40 has an image memory 42. In the present embodiment, three separate still images A, B, and C are displayed as a motion image, and first through third image data memories 42A-42C are accordingly prepared.

The number of still images that can be selected is not limited to the above value of the present embodiment; in fact, it is in principle possible to switch and display motion images up to the number of still images corresponding to the number of the LCD panels installed (in the case of a frame rate of 30 frames/s). As the image memory 42, a large-capacity non-volatile semiconductor memory or a hard disk unit can satisfactorily be applied. In the present embodiment, a semiconductor memory is used.

The display control section 40 also has a communication control section 44 for accumulating items of the image data on still images to be sent to the image memory 42. The communication control section 44 is provided so as to synchronize all components of the system with each other through communication with the adjacent LCD devices 11 and/or the control section 12. The communication control section 44 can also transfer and/or receive information to and/or from the control section 12 described later.

The image memory 42 stores, via this communication control section 44, items of image data (Ai, Bi, and Ci) of the corresponding frame number (#i) among items of image data which has been transferred from the control section 12. Provision of a communication control section 44 enables updating of image data and changes thereto. This is because it is preferable for image data to be changed in accordance with a time zone etc.

Among these various items of information received by the communication section 44, an LCD drive section 46 receives a variety of kinds of timing signals. This timing signal used herein generally refers to a clock signal CK that is used to read or write image data, or to a synchronization signal such as a horizontal drive signal (H) or a vertical drive signal (V).

The timing signal output from the LCD drive section 46 is supplied as a signal used to drive the display panel 20. The communication control section 44 receives a flash pulse PL transferred from the control section 12. The communication control section 44 supplies the received flash pulse PL to the light-emitting device 30 via the light emission drive section 50. The light-emitting device 30 is so controlled as to be flashed at a time when the flash pulse PL is received.

The timing signal output from the LCD drive section 46 is also supplied to an image memory selection section 48. The image memory selection section 48 is a control circuit that controls the image memory 42. The image memory selection section 48 also receives the flash pulse PL and a memory select signal Ma which are separated in the communication control section 44.

The image memory selection section 48 exercises any control so as to decide which image data memory of the image memories 42 should be accessed. By specifying a memory select signal MS (MSa in the figure) and an address bus for the image memory 42, any of the first through third image data memories 42A-42C can be specified sequentially so that image data stored in the specified memory may be read in frame units in synchronization with the clock signal CK.

Which of the image data memories should be first selected is determined in advance by the order in which the LCD panels are arranged and the number (three in the present embodiment) of still images that are to be displayed; the present embodiment has exemplified a case in which a memory select signal MSa has been sent from the control section 12 to select the first image data memory 42A.

Instead of utilizing the memory select signal MSa generated by the control section 12, the memory select signal MSa may of course also be generated in the image memory selection section 48 itself, by using, for example, a trigger signal from the control section 12.

Image data is read from the image memory 42 in synchronization with the flash pulse PL. In the present embodiment, reading of image data starts immediately after a flash (immediately after a strobe light emission). This is done so as to avoid unstable display of motion images even when the flash pulse PL fails to be synchronized with the vertical synchronization signal VP. Details of this aspect will be described later.

When the flash pulse PL occurs, switchover is made to the image data memory from which image data is to be read. In other words, until the flash pulse PL occurs, the same image data memory is accessed so as to read image data therefrom in succession.

It should be noted that the number of frames of the same still image which can be stored in the image memory 42 varies with a traveling speed of the electric train 4. This is because if the level of speed decreases, a larger number of frames is displayed by each of the LCD devices 11, so that a correspondingly larger number of frames is necessitated to be stored in the image memory 42.

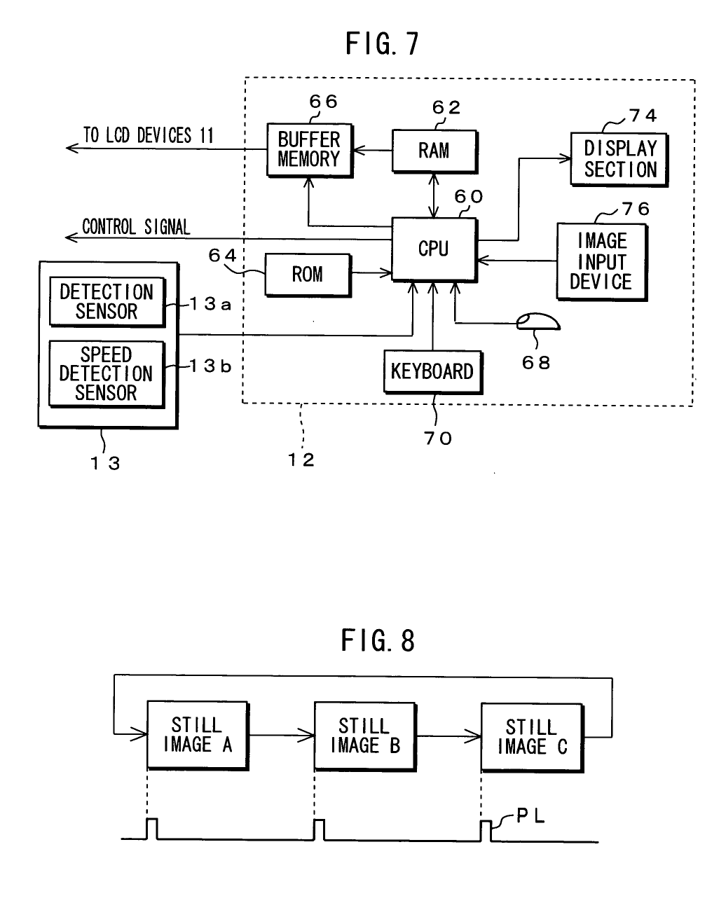

FIG. 7 shows a configuration of the control section 12. Besides functioning as a supply source of still images, the control section 12 generates a flash pulse PL or the like having a cycle corresponding to a traveling speed of the electric train 4 that is detected by the speed detection section 13.

The speed detection section 13 has a detection sensor 13a for detecting an approach of the electric train 4 and a speed detection sensor 13b for detecting a traveling speed of the electric train 4. The detection sensor 13a remains turned on from the moment that the train 4 enters a predetermined section, for example, a section in which the apparatus 100 (specifically, LCD device 11a) is installed, up to the moment that the last car of the electric train 4 has completely passed through the section. The control section 12 receives a detection signal from the detection sensor 13a and a signal of a traveling speed of the electric train 4 detected by the speed detection sensor 13b.

The control section 12 can generally be constituted of a personal computer. FIG. 7 shows an example of the configuration of the control section 12 in a case where a personal computer is used. This control section 12 has, as is well known, a central processing unit (CPU) 60, an RAM62 for storing data on still images, an ROM64 serving as a memory in which a control program is stored, a buffer memory 66, an external input device (mouse 68 in this case), a keyboard 70 through which control information is input, and the like.

The CPU 60 controls operations of the entirety of the apparatus 100 by using the RAM62 as its working area in accordance with the control program stored in the ROM 64. The CPU 60 further has a function of calculating a cycle of a flash pulse PL based on a traveling speed of the electric train 4 detected by the speed detection sensor 13b, and of generating a flash pulse PL that corresponds to that cycle.

The CPU 60 also has a function of selecting a still image input through an image input device 76 and store the image into the RAM 62. The CPU 60 selects the three still images A, B, and C to be actually provided from the still images thus stored, and delivers them to the LCD devices 11. A plurality of still images to be previously delivered may be prepared as a delivery program, in which eventually the delivery program is displayed on a display section 74 so that any necessary one of the still images can be selected.

The detection sensor 13a is installed at a position closest to the first LCD device 11a installed at the side where the electric train 4 approaches, and thus can detect an approach of the electric train 4. A signal generated by the detection sensor 13a after the train 4 has passed therethrough is supplied to the CPU 60.

According to an embodiment of the present invention, when switching sequentially plural separate still images at the same LCD device 11 so as to provide a flash, in synchronization with a light-emission flash pulse PL supplied to the LCD panel 20, image data on these still images is written sequentially onto the LCD panel for every flash timing immediately after the flash caused by this flash pulse PL. It is thus possible to switch sequentially three different still images in a toggling manner and display them in synchronization with a flash pulse PL. This switched display processing is repeated until the electric train 4 passes therethrough completely.

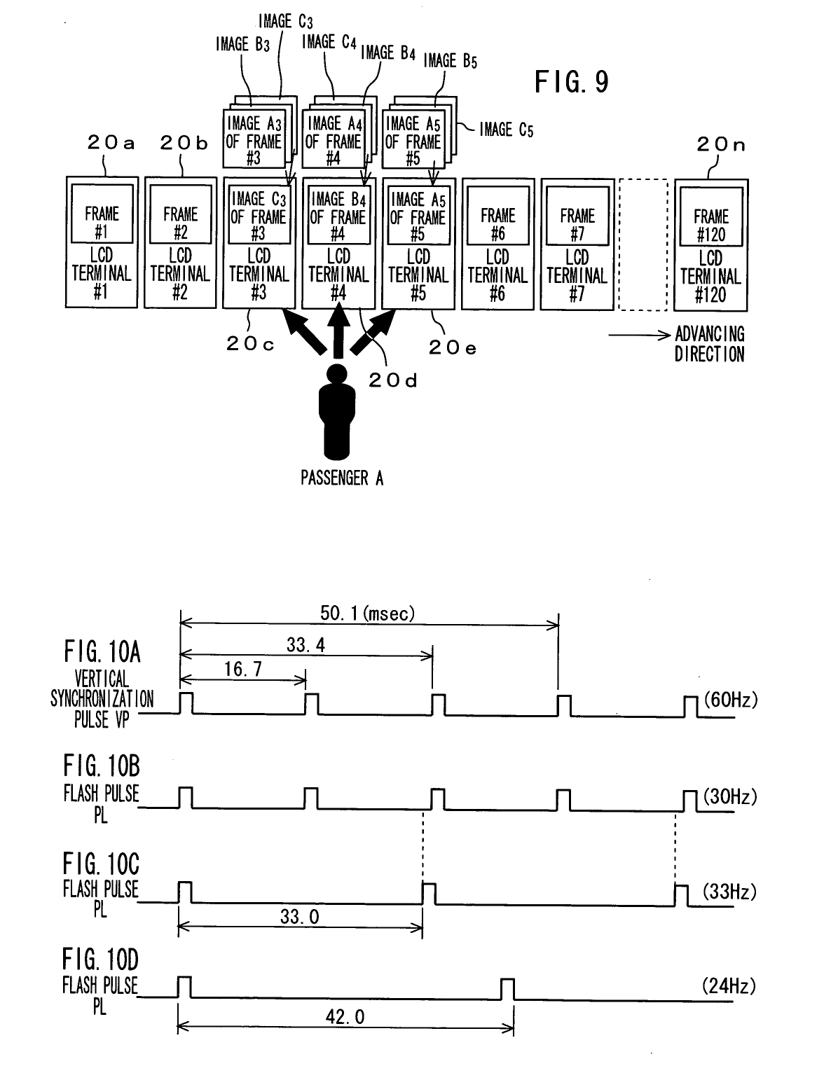

The display order can be set arbitrarily. For example, it can be set in such a manner that, as shown in FIG. 8, still images A, B, C, A, . . . are sequentially switched and displayed in synchronization with a flash pulse PL (which will be described later). For convenience of explanation, the following will describe such the switching and displaying by using the third through fifth LCD panels 20c-20e, as shown in FIG. 9.

At a point of time when the third LCD panel 20c flashes a still image of a third frame (frame No. 3), the first image memory 42A stores a first still image (image data) A3 corresponding to this third frame (frame #3), the second image memory 42B stores a second still image B3 corresponding to the third frame, and the third image memory 42C stores a third still image C3 corresponding to the third frame.

Therefore, at the fourth LCD panel 20d, the first image memory 42A stores a first still image A4 corresponding to a fourth frame (frame #4), the second image memory 42B stores a second still image B4 corresponding to the fourth frame, and the third image memory 42B stores a third still image C4 corresponding to the fourth frame.

Similarly, the first image memory 42A in the first image memory of the fifth LCD panel 20e stores a first still image AS corresponding to the fifth frame (frame #5), the second image memory 42B stores a second still image B5 corresponding to the fifth frame, and the third image memory 42C stores a third still image C5 corresponding to the fifth frame.

In this condition, when the LCD panel 20e flashes a still image A (AS), the adjacent one-frame-earlier LCD panel 20d flashes a still image B (B4) and the two-frame-earlier LCD panel 20c flashes a still image C (C3). As a result thereof, a passenger A can view three different motion images simultaneously. In other words, during a period between the moment when the electric train 4 approaches and the moment when it passes through the apparatus 100, the passenger A can view three different motion images on the display devices which he or she faces.

Image data is read from the image memory 42 and also the image data thus read is written into the LCD panel 20 in synchronization with a flash timing. In particular, immediately after the flash, image data is read or written.

This is because instability in the display of a motion image caused by a shift between the timing of an image data reading or writing and a flash timing is eliminated. Further, in a case where a flat display panel like an LCD panel is used as the display device, this is also done in order to achieve a flash that takes into consideration a reaction time peculiar to the flat display panel.

The following will describe these matters with reference to FIGS. 10A through 10D.

Each of these FIGS. 10A through 10D shows a relationship between flash pulses PL and a synchronization signal. To configure a motion image by still images having a frame rate of 30 frames/s, a reading operation from the image memory 42 is first performed in synchronization with the vertical synchronization signal (pulse) VP having 60 Hz, as is well known (see FIG. 10A).

In a case where the electric train 4 is traveling at a speed of 60 km/h, if a repetition frequency of the flash pulse PL is set to 30 Hz (see FIG. 10B), the timings of reading and writing the image data and the flash timing are completely synchronized with each other. This causes the images to be flashed stably even when plural motion images are switched from one to another.

If on the other hand, the traveling speed thereof deviates from this prescribed value, the flash timing deviates from the timings of reading and writing the image data. For example, if the traveling speed is higher than the prescribed speed by 10%, the flash pulse PL occurs ahead of the vertical synchronization signal VP, thus resulting in a shift in synchronization (see FIGS. 10A and 10C). This shift causes a case where a flash timing occurs before transcription of image data has been completely terminated, thus resulting in unstable display of motion images. To configure a motion image by still images having a frame rate of 24 frames/s, the repetition frequency of the flash pulse PL becomes 24 Hz, in a circumstance of which the flash is controlled in asynchronous mode from scratch (see FIG. 10D).

According to this embodiment of the invention, reading and writing image data is synchronized with the flash pulse PL. In other words, immediately following a strobe light emission caused by the flash pulse PL, image data that is to be next read, is read and then sequentially written onto the LCD panel 20. Until the next flash is performed, the same image data is sequentially overwritten as it is being read.

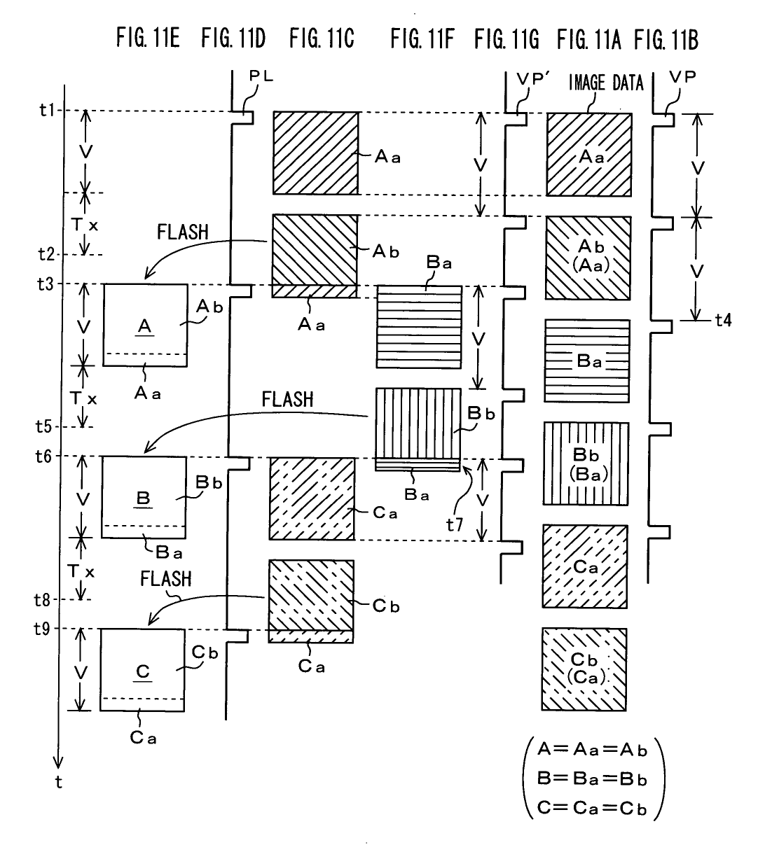

The following will describe procedure with reference to FIGS. 11A through 11G. FIGS. 11A through 11G show a case of a motion image configured by still images having a frame rate of 30 frames/s, in which a reading operation from the image memory 42 is switched at a flash timing. The traveling speed of the electric train 4 is deemed to be 66 km/h, which is 10% higher than the prescribed speed thereof.

FIG. 11A shows field-specific image data, in which image data Aa (Ba, Ca, . . . ) read in an odd-numbered field and image data Ab (Bb, Cb, . . . ) read in an even-numbered field are of the same image data A(B, C, . . . ). Therefore, each of the items of image data constitutes one frame of image data in the following description.

As shown in FIGS. 11A and 11B, at an initial point (a period of time t1), image data Aa is read in synchronization with the vertical synchronization signal VP. In synchronization with this reading operation, a write operation onto the LCD panel 20a is performed (see FIGS. 11A and 11C). When one frame of the image data Aa has been read completely, image data Ab (=Aa) is read in synchronization with the next vertical synchronization signal VP and then written (overwritten in this case) onto the LCD panel 20a (see FIGS. 11A and 11B). As is well known, writing operations of image data onto the LCD panel 20a are performed continually, so that writing processing is continually performed for every vertical cycle.

On the other hand, in the above example, the flash pulse PL generated on the basis of the traveling speed of the electric train 4 has a frequency of 33 Hz (see FIG. 11D), so that the flash timing caused by the flash pulse PL occurs slightly earlier than the second vertical cycle. In other words, the flash timing occurs at a period of time t3 that is earlier than a period of time t4 at which the second vertical cycle occurs (see FIG. 11E).

At the period of time t3, the image data Ab of one frame that has been read immediately before the period of time t3 is not completely written onto the LCD panel 20a to remain a little amount of data, and a slightly remaining portion thereof is not overwritten. This remaining portion provides an image data that has been not overwritten, which is still the image data Aa.

Therefore, image data of one frame at the time of strobe light emission has a configuration of (Aa+Ab) as shown in FIG. 11E. The items of image data, Aa and Ab, are each part of the same image data A and there is no sense of incongruity in the image at the time of strobe light emission.

When a flash occurs at a period of time t3, roughly simultaneously, (in actual practice, at the moment that the strobe light emission is terminated), reading and writing of the next image data start (see FIG. 11F). Image data Ba is read with a lapse of time of one vertical cycle, during which time writing is also performed onto the LCD panel 20a (FIG. 11F). On the next one vertical cycle, overwriting processing that overwrites the image data Ba by use of image data Bb is performed. Therefore, from the second flash onwards, image data is read or written in synchronization with a vertical synchronization pulse VP′ (see FIG. 11G) that is synchronized with the flash pulse PL.

The second flash occurs at a period of time t6 that is earlier than a period of time t7, at which the second vertical cycle comes to an end. As a result thereof, as in the case of the first flash, the image data Bb that has been read immediately before the period of time t7 is not completely written onto the LCD panel 20a to remain a few amount of data. This slightly remaining portion is not overwritten. This remaining portion provides an image data that has been not overwritten, which is still the image data Ba.

Therefore, in the case of the second flash also, image data of one frame at the time of the strobe light emission has a configuration of mixed image data (Ba+Bb) (see FIG. 11F), and the items of image data Ba and Bb are respectively constituted of a front half portion and a part of a rear half of the same image data B. The images made of the same image data B are flashed.

Thus, since image data that is of one-frame earlier and has already been written is overwritten only until the next flash is performed, even when a flash timing occurs before image data of one frame has been completely overwritten, image data prior to overwriting and image data that have been completely overwritten are in practice both nothing other than image data of the same frame. In other words, items of different image data are not written onto the same LCD panel and not flashed in that condition, and a stable display of a motion image can be secured.

In order to achieve control of reading and writing such image data, the image memory selection section 48 shown in FIG. 6 receives a memory select signal MSa as well as the flash pulse PL, and specifies any one of the image data memories 42A through 42C that is selected first by the memory select signal MSa and sequentially specifies the image data memories 42A through 42C in a toggling manner in synchronization with the flash pulse PL. Further, an address bus is specified in such a manner that reading operations from the image data memories 42A through 42C can be performed in synchronization with the flash pulse PL. The above control enables processing of reading and writing of the image data to be realized.

Further, as described above, in the case of a flat display panel such as an LCD panel, only after the elapse of a reaction time Tx (response time) that follows the end of writing of image data and that is peculiar to the relevant apparatus, the written image can be flashed. The reaction time Tx is normally 16 ms, but the actual time tends to vary slightly depending on the manufacturer, or on the actual product used.

In this case, since, as is clear from FIGS. 10A through 10D, the cycle of the flash is 33 ms, a relationship of 33 ms>V+Tx=16.7 ms+16 ms is established. In the example of FIGS. 11A-11G, at a period of time t2 that is earlier than a period of the flash time t3, image data to be next flashed is determined. The image data Ab written during a period of the second vertical cycle is the same as the image data Aa written one frame earlier, so that a reaction time Tx necessary for next flash can be secured in plenty of time before the next image flashing starts, and no problem in particular thus occurs. Such a manner, plural motion images can be displayed stably even in circumstances where plural separate still images is switched one after another for every flash timing.

Also, in a case where a motion image is configured by the still images having a frame rate of 24 frames/s, similarly, instability will occur in the motion image, and in these circumstances also image data can be read and written onto the LCD panel in synchronization with the flash pulse.

If the frame rate is 24 frames/s, the flash pulse PL has a cycle of 42 ms, so that flash control can be conducted every three to four vertical cycles.

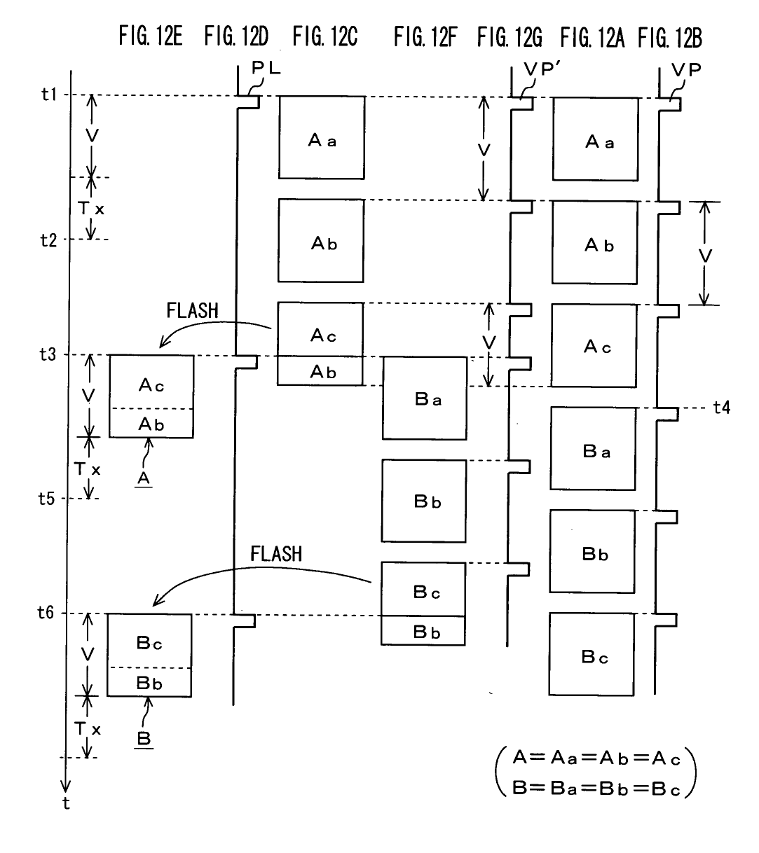

FIGS. 12A through 12G show an example of this flash, in which a flash timing comes at a period of time t3 that is earlier than a period of time t4 at which the fourth vertical cycle occurs (FIGS. 12 and 12D). However, details of this will be omitted. At this timing, the image data Ab written one frame earlier is partially overwritten by the image data Ac of the fourth vertical cycle. Therefore, data on an image to be flashed is of mixed data (Ac+Ab) (see FIG. 12E), but since Aa=Ab=Ac=A, a motion image is displayed that is dependent only on still image A. Therefore, the motion image will not be irregular. Further, it can be readily understood that the reaction time Tx for the LCD panel 20 has been sufficiently satisfied. This holds true also for the next flash timing.

Therefore, according to the embodiment of the present invention, even if displaying a motion image configured by the still images having a frame rate of 24 frames/s, by synchronizing timings of writing and reading image data with a flash timing, plural separate motion images can be displayed stably.

### Second Embodiment

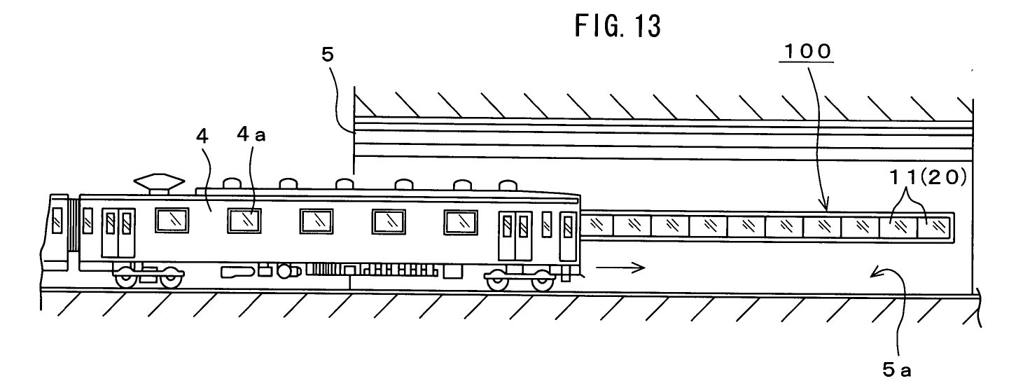

FIG. 13 shows a configuration of an apparatus 100 for displaying image wherein a so-called seamless structure, in which LCD panels 20 are seamlessly arranged and installed in a tunnel 5.

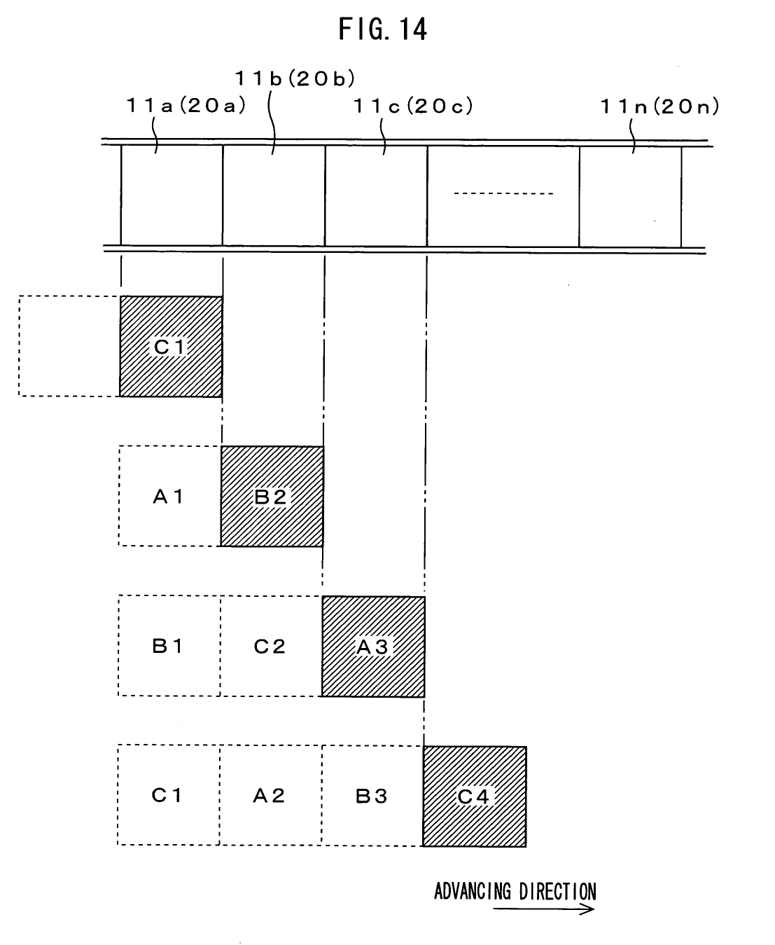

In this embodiment, to display a still image of one frame at each of the LCD panels, a configuration as shown in FIG. 14 is provided. For example, in a case where a horizontal width (size) of the LCD panel 20 is set to 47 cm, in order to show 30 images per second, a traveling speed (prescribed speed) of the mobile object for displaying a still image of one frame at each of the LCD panels becomes 50 km/h.

Therefore, between each of the LCD panels 20 and three different still images A, B, and C, a relationship as shown in FIG. 14 is established. In such a seamless configuration, by conducting such the same control as that for the first embodiment, plural motion images can be displayed stably even when plural separate still images is switched and flashed at a flash timing.

### Third Embodiment

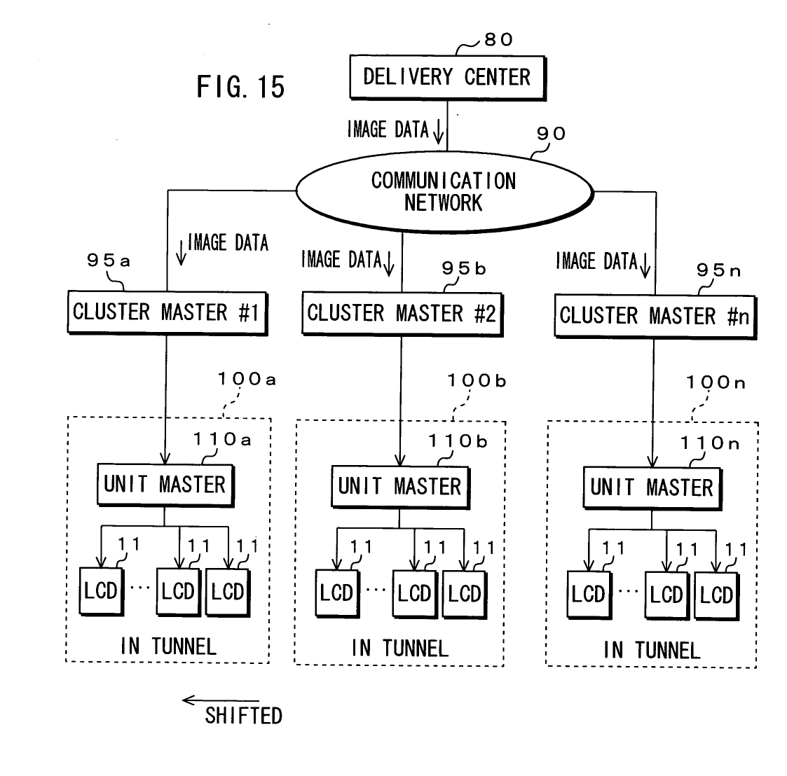

FIG. 15 shows a configuration of an image delivery system for delivering image data on still images by way of a network.

As shown in FIG. 15, a delivery center (external delivery device) 80 first transfers the image data to cluster masters 95a, 95b, . . . , and 95n via a communication network 90 and then each of the cluster masters 95a, 95b, . . . , and 95n transfers the image data to each of the apparatuses 10a, 100b, . . , and 100n for displaying image. The apparatuses 10a, 100b, . . , and 100n respectively include unit masters 110a, 10b, . . . , and 110n, and the image data is supplied to each of the LCD devices 11 via each of the unit masters 110a, 110b, . . . , and 110n. Therefore, the unit masters 110a, 110b, . . . , and 110n in the present embodiment correspond to the control section 12 shown in FIG. 6.

Building up a delivery system in such a manner allows to be obtained any excellent advantage such that not only can management in a single tunnel be realized but also management in the apparatuses 100 installed in plural tunnels excavated on a same route can be performed, as well as management in the apparatuses 100 installed in affiliated railroad traffic companies of the same group can be performed collectively.

Although the above embodiments have employed a CPU 60 as the control section 12, the present invention is not limited thereto. For example, hardware that constitutes a control circuit may be used. In such cases, high speed processing can be achieved.

Further, although the above embodiments have provided the speed detection section 13 on a foremost LCD panel 20 in a direction from which a train approaches, the speed detection section 13 may also be provided to the rearmost LCD panel 20. In this case, even when the electric trains (movable objects) 4 approach the position in which the LCD panels 20 are installed from both directions, the apparatus is capable of coping with both of the electric trains at the same time.

### Fourth Embodiment

Each of the first through third embodiments has concerned a case where a flat display panel like an LCD, especially a full-size flat display panel, has used as a display panel 20 equipped to the display device 6. According to an embodiment of the present invention, however, a flat display panel having a strip shape and a size other than the full size also can be applied thereto.

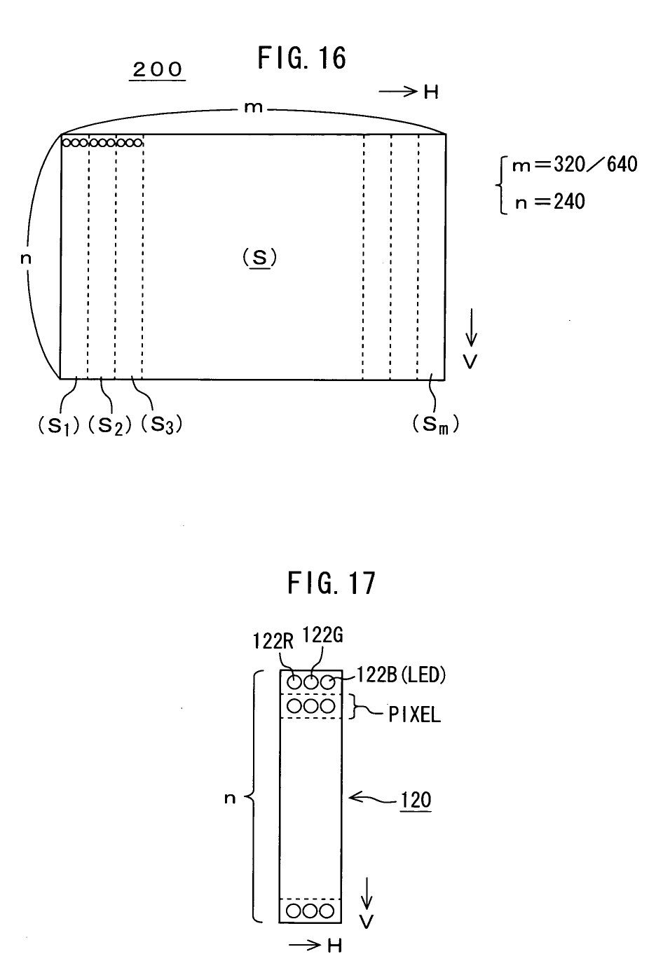

By, for example, dividing by m number in a horizontal direction a full-size flat display panel 200 having a matrix composed of m number of horizontal pixels by n number of vertical pixels, as shown in FIG. 16, enables to be formed a strip-shaped display panel 120 configured by one horizontal pixel and n number of vertical pixels, as shown in FIG. 17. Such a strip-shaped display panel 120 can be used as a display panel for an apparatus for displaying image according to an embodiment of the present invention.

As the strip-shaped display panel 120, a light-emitting element such as a light-emitting diode (LED) may be satisfactorily applied instead of an LCD. Using an LED enables a strip-shaped display panel to be manufactured easily and inexpensively. Moreover, because the display panel 120 has a strip shape, the panel 120 can be installed simply. In circumstances where a color display panel is configured by use of an LED, as shown in FIG. 17, each pixel can, for example, be configured by arranging in line three LEDs 122R, 122G, and 122B that respectively emit the primary colors of red, green, and blue.

When this kind of strip-shaped display panel 120 is used, all the items of still image data S1, S2, S3, . . . , and Sm on vertical lines each of which is constituted of m number of pixels, as shown in FIG. 16, are sequentially read and displayed within a display period of one flash pulse PL shown in FIG. 8. This enables still image (full-size) of one screen to be still displayed even if the strip-shaped display panels 120 of one pixel are used. Then, by flashing the still image every vertical scanning cycle, motion image can be displayed. It is to be noted that the above-described number of horizontal pixels, m is normally of 320 or 640, and the number of vertical pixels, n is generally about 240.

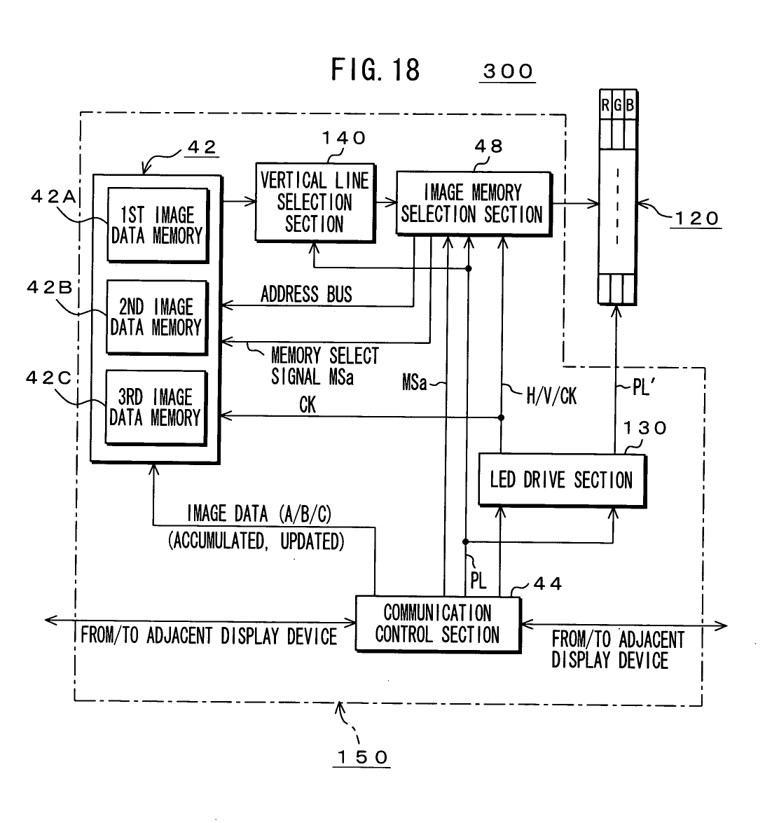

FIG. 18 shows a configuration of a flash control section 150 in an LED displaying apparatus as an apparatus for displaying image, which uses the one-vertical-line display panel 120 having a pixel matrix (m=1, n). This display control section 150 has a basic configuration modeled after a configuration of a display control section 40 shown in FIG. 6, and thus for ease of reference, their common components are indicated by the same symbols, a detailed explanation of which will be omitted.

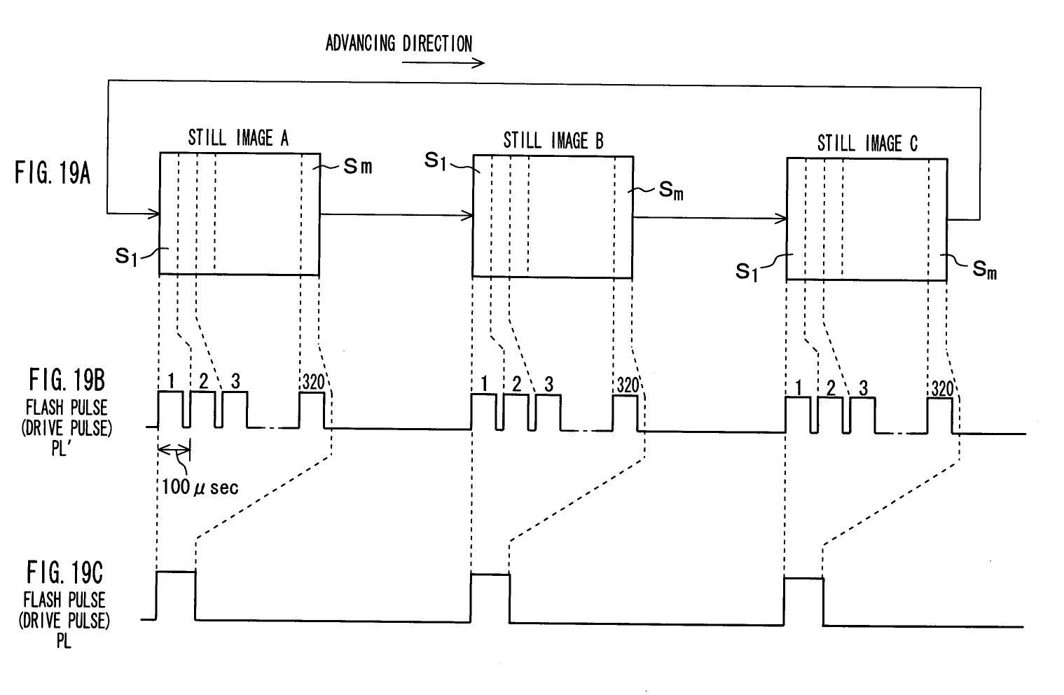

When a self-luminous element such as an LED is used as the display panel 120, in contrast to a case in which an LCD is used, it may become unnecessary to use light-emission device such as a backlight, and to perform any writing processing on image data taking into consideration a reaction time of an LCD. Therefore, an LED drive section 130 as shown in FIG. 18 is provided, and a drive pulse generated by this LED drive section 130 can accordingly be supplied to the display panel 120 as a flash pulsed PL′ (see FIGS. 19B and 19C).

Furthermore, a vertical line selection section 140 is provided between the memory device 42 and an image memory selection section 48 to select sequentially still image data that have been divided by m, by as much as each vertical line. Timing for this selection is synchronized with the above-described flash pulse PL′. Thus, from a specific memory selected by the image memory selection section 48, items of still image data Si of one vertical line are read and supplied to the display panel 120 corresponding to any pixel Pi (i=1-240). Then, when the flash pulse PL′ has been supplied, all of the pixels Pi of the one vertical line are simultaneously flashed.

This display processing is continually performed within a display period of one flash pulse PL′ and repeated m number of times in total with a horizontal shift thereof being sequentially performed. Thus, still image data of each vertical line can be sequentially read and supplied to its corresponding display panel 120. By continually performing this divided-image flash m number of times within a flash period of one flash pulse PL′, still image of one screen can be flashed.

As shown in FIG. 16, in the case of a display panel in which one screen (full size) is configured by 320 (=m) pixels horizontally and 240 (=n) pixels vertically, in order to flash all the vertical lines of divided images S1, S2, . . . , and Sm within a flash period of one flash pulse PL′, a pulse width of the flash pulse PL′ is set to about 100 ns (see FIG. 19B).

Thus, even if the strip-shaped display panel 120 is use when all of the divided still image by m (strip-shaped images) can be flashed within a flash period of one flash pulse PL′, a viewer can view an image that is apparently the same as a full-sized still image (of one screen). In other words, it is possible to achieve the same flash condition as in the case where he or she can view one still image using a full-size two-dimensional flat display panel.

Because the display panel 120 also has a strip shape, the panel 120 is very inexpensive in terms of unit costs, and hence it difficult to be subjected to limitations in terms of numbers of panels to be used. Such the display panel 120 is not limited in terms of installation portion thereof. In the panel, less man-hour is accordingly necessary. Any peripheral drive circuit systems for the display panel 120 can also be simplified.

In the strip-shaped display panel 120, the number of horizontal pixels is not limited to m=1. For example, to be as many as between around 10 and 50, this number of pixels, m can be considered. Provided that the number of pixels is confined within such a range, the panel can be manufactured easily and its control is simple. For example, in a case where the number of horizontal pixels in a full-size configuration is 320 (=m), if m is set to 10, a two-dimensional display panel can be provided in a strip shape in which 10 pixels are arranged in a horizontal scan direction. In such a case one screen may be divided by 32 in a horizontal scan direction thereof and can be sequentially switched in flash, thus resulting in a simplified configuration of the flash control section 150.

The apparatus and method for displaying image related to the above embodiments of the present invention can be utilized as an advertising medium put in places such as subways, places by a roller coaster, for example, in amusement parks or places by an elevator.

It should be understood by those skilled in the art that various modifications, combinations, sub-combinations and alternations may occur depending on design requirements and other factors insofar as they are within the scope of the appended claims or the equivalents thereof.

What is claimed is:

1. An apparatus for displaying image, said apparatus comprising:
plural display means separately arranged to each other at a predetermined distance along a route of a mobile object, said display means receiving and flashing still images to provide a consecutive image constituted of the still images, and each of said display means having a display panel arranged at a position thereof that can be viewed from a passenger on the mobile object;
speed detection means for detecting a traveling speed of the mobile object;
a control section for allowing to be generated, on the basis of the traveling speed of the mobile object obtained from the speed detection means, a flash pulse to be supplied to the display means; and
a display control section for controlling the display means to flash the still images sequentially on the display panel provided for each of the display means, said display control section including an image memory for storing items of data on plural separate still images and a light emission drive section for driving the display panel to which the flash pulse is supplied,
wherein the display control section conducts writing control to select the plural still images sequentially one-by-one and to write the items of data on the still images onto the display panel.

2. The apparatus according to claim 1,
wherein in the display control section, selection of the still image and processing of writing the items of data on the still images onto the display panel are performed in synchronization with the flash pulse; and
wherein the display control section includes an image memory selection portion for writing the items of data on the still images immediately after a flash caused by the flash pulse in synchronization with the flash pulse.

3. The apparatus according to claim 1, wherein different items of data on the still image are written on the display panels that are adjacent to each other, and different still images are displayed thereon.

4. The apparatus according to claim 1, wherein the display panel is a full-size two-dimensional flat display panel and a liquid crystal display panel is employed.

5. The apparatus according to claim 1,
wherein the display panel is a flat display panel having a strip shape, on which a full-size still image is divided and displayed; and
wherein among the items of data on the full-size still image, items of data on the still image that match a display size of the display panel are sequentially supplied to the flat display panel having the strip shape, thereby to display sequentially parts of the full-size still image and thus, to display the full-size still image within a period of flash time for the flash pulse.

6. The video display apparatus according to claim 5, wherein a display element used in the flat display panel is a light-emitting diode.

7. An apparatus for displaying image, said apparatus comprising:
plural display devices separately arranged to each other at a predetermined distance along a route of a mobile object, said display devices receiving and flashing still images to provide a consecutive image constituted of the still images, and each of said display devices having a display panel arranged at a position thereof that can be viewed from a passenger on the mobile object;
a speed detection device for detecting a traveling speed of the mobile object;
a control section for allowing to be generated, on the basis of the traveling speed of the mobile object obtained from the speed detection device, a flash pulse to be supplied to the display devices; and
a display control section for controlling the display devices to flash the still images sequentially on the display panel provided for each of the display devices, said display control section including an image memory for storing items of data on plural separate still images and a light emission drive section for driving the display panel to which the flash pulse is supplied,
wherein the display control section conducts writing control to select the plural still images sequentially one-by-one and to write the items of data on the still images onto the display panel.

8. A method for displaying image in which still images to be supplied to the plural display means are flashed to provide a consecutive image constituted of the still images, each of said display means being separately arranged to each other at a predetermined distance along a route of a mobile object, the method comprising:
a first step of supplying plural separate still images to the same display means and flashing the still images sequentially at predetermined time intervals; and
a second step of writing image data on the still images onto the display means in synchronization with a light-emission flash pulse supplied to the display means.

9. The method according to claim 8, wherein during the second step, the still images are written onto the display means immediately after a flash caused by the flash pulse for flashing the display means has been performed in synchronization with this flash pulse.

10. The method according to claim 8,
wherein, when the display means is a flat display panel having a strip shape, a full-size still image is divided and displayed on this flat display panel; and
wherein among the items of data on the full-size still image, items of data on the still image that match a display size of the display panel are sequentially supplied to the flat display panel having the strip shape, thereby to display sequentially parts of the full-size still image and thus, to display the full-size still image within a period of flash time for the flash pulse.

11. The method according to claim 10, wherein a display element used in the flat display panel is a light-emitting diode.

12. A method for displaying image in which still images to be supplied to the plural display devices are flashed to provide a consecutive image constituted of the still images, each of said display devices being separately arranged to each other at a predetermined distance along a route of a mobile object, the method comprising:
a first step of supplying plural separate still images to the same display device and flashing the still images sequentially at predetermined time intervals; and
a second step of writing image data on the still images onto the display devices in synchronization with a light-emission flash pulse supplied to the display devices.
